(19) United States
(12) Patent Application Publication
(10) Pub. No.: US 2006/0287890 A1
(43) Pub. Date: Dec. 21, 2006

(54) Method and apparatus for organizing and integrating structured and non-structured data across heterogeneous systems

(75) Inventors: William W. Stead, Nashville, TN (US); Dario Giuse, Nashville, TN (US); Randall Armstrong Bates, Franklin, TN (US); Jim Najib Jirjis, Nashville, TN (US); David Bruce Staggs, Hermitage, TN (US); Randolph Arthur Miller, Brentwood, TN (US)

Correspondence Address: MILES & STOCKBRIDGE PC, 1751 PINNACLE DRIVE, SUITE 500, MCLEAN, VA, 22102-3833, US

(73) Assignee: Vanderbilt University, Nashville, TN (US)

(21) Appl. No.: 11/152,377

(22) Filed: Jun. 15, 2005

(51) Int. Cl. G06F 19/00

(52) U.S. Cl. 705/3

(57) ABSTRACT

The invention relates to an integrated method of identifying, aggregating and making accessible information from multiple heterogeneous sources including receiving data about an entity from a remotely located source; parsing the data using a parser specific to the remotely located source; if the entity does not have an existing unique entity identifier, assigning a unique entity identifier to the entity; associating the data with the unique entity identifier for the entity; associating a version number with the data and the unique entity identifier; storing the data and the version number in a location specific to the remotely located source; aggregating the entity data accumulated from multiple remote sources and stored in locations specific to the remote source in a common, logical view of the entity record; populating the common, logical entity record in a high speed memory with the data; making the entity data available from the high speed memory for use by one or more applications independently of each other and to one or more local users of a central repository and to one or more geographically remote users of the central repository; and limiting the use of the entity data and information in the central repository to only authorized users across a geographically distributed area.

### REFERENCE TO GOVERNMENT GRANT

This invention was made in part with Government support under Grant No. 5G08 LM05443, awarded by the National Library of Medicine. The Government has certain rights in this invention.

### BRIEF DESCRIPTION OF THE DRAWINGS

The present invention will be described with reference to the accompanying drawings.

FIG. 1 is a block diagram of a known system framework for organizing, aggregating and integrating structured and non-structured data from a number of heterogeneous systems that may be used in one or more embodiments of the present invention.

FIG. 2 is a block diagram of a known integration model for integrating data from heterogeneous systems into the system framework of FIG. 1 that may be used in one or more embodiments of the present invention.

FIG. 3 is a detailed block diagram of a known information services layer in the system framework of FIG. 1 that may be used in one or more embodiments of the present invention.

FIG. 4 is a block diagram showing multiple scenarios for virtual data integration of data distributed across known heterogeneous systems into the information services layer of FIG. 3 that may be used in one or more embodiments of the present invention.

FIG. 5 is a detailed block diagram of a known self-organizing workflow model in the system framework of FIG. 1 that may be used in one or more embodiments of the present invention.

FIG. 6 is a detailed block diagram of a known user interface for use in accessing the self-organizing workflow of FIG. 5 that may be used in one or more embodiments of the present invention.

FIG. 7 is a block diagram of a system framework for organizing, aggregating and integrating structured and non-structured data from a number of remotely located heterogeneous systems, in accordance with one or more embodiments of the present invention.

FIG. 8 is a top-level functional block diagram of an implementation of an integration architecture framework for integrating structured and non-structured data from a number of remotely located heterogeneous systems into the system framework of FIG. 7, in accordance with one or more embodiments of the present invention.

FIG. 9 is a block diagram illustrating possible structures of a regional databank for use in the system framework of FIG. 7, in accordance with one or more embodiments of the present invention.

FIG. 10 is a functional data flow diagram associated with a regional databank in the system framework of FIGS. 7, 8 and 9, in accordance with one or more embodiments of the present invention.

FIG. 11 is a top-level flow diagram illustrating the process of adding patient data into the regional databank and system framework of FIGS. 7, 8 and 9, in accordance with an embodiment of the present invention.

### DETAILED DESCRIPTION

At best, current enterprise solution frameworks only allow a healthcare organization to aggregate and integrate patient data and information from external and internal sources using traditional front-end consolidation and/or consolidated data store techniques. However, in today's distributed world and healthcare environment, it is desirable for patient data and information available from multiple heterogeneous systems from both local and remotely located sources be used for virtual data integration and aggregation into a central data repository. This central data repository may be accessible by authorized users to provide, update and query information on patients in the central data repository. This capability can not only significantly reduce the time needed to receive information and test results needed to treat a patient, but can also mean the difference between life and death when quick access to the latest information on the patient, for example, past medical history, drug allergies and/or current medication contraindications provided by other sources.

Although the embodiment of the present invention described herein relates to a healthcare/patient record system, other implementations of the structure of the system are contemplated. These other implementations may include, but are not limited to, for example, for law enforcement, the system may aggregate and integrate criminal records from multiple different local (e.g., city, town, county), state, federal, and even international jurisdictions and agencies. While the overall system structure described below may remain the same, the type of data stored would be different, for example, instead of patient records, x-rays and the like, the system would store criminal records and information (e.g., “rap sheet”, fingerprints, photos, etc.) as dynamic criminal records and separate storage locations would be created for each jurisdiction and/or agency that provides data and information to the system and access could be limited to authorized users at multiple levels of the data. Alternatively, other embodiments of the system may be used for tax information (e.g., real property, income, etc.) that may be collected on the local, state and federal levels for people and/or companies. Yet other alternatives may include loan and/or credit reporting; academic testing reporting; etc. The foregoing alternative embodiments are merely illustrative of the potential uses/applications of the present invention. Accordingly, the above examples should not be construed in any way to limit the possible alternative embodiments of the present invention.

For example, current enterprise solution frameworks allow a healthcare organization to:
Aggregate and integrate the broad spectrum of structured & non-structured healthcare information both within and across disparate healthcare organizations;
Separate clinical information in application-independent storage from application logic found in traditional systems. View traditional systems both within and external to an organizations as components (e.g., transaction processors, data capture devices), not as data repositories;
Centralize global functions (ordering, notification, etc.) that can scale-up and provide consistency across the enterprise; and
Utilize messaging and communication capabilities that support collaborative and highly multi-tasked environments
Leverages internet-based technology to expand the

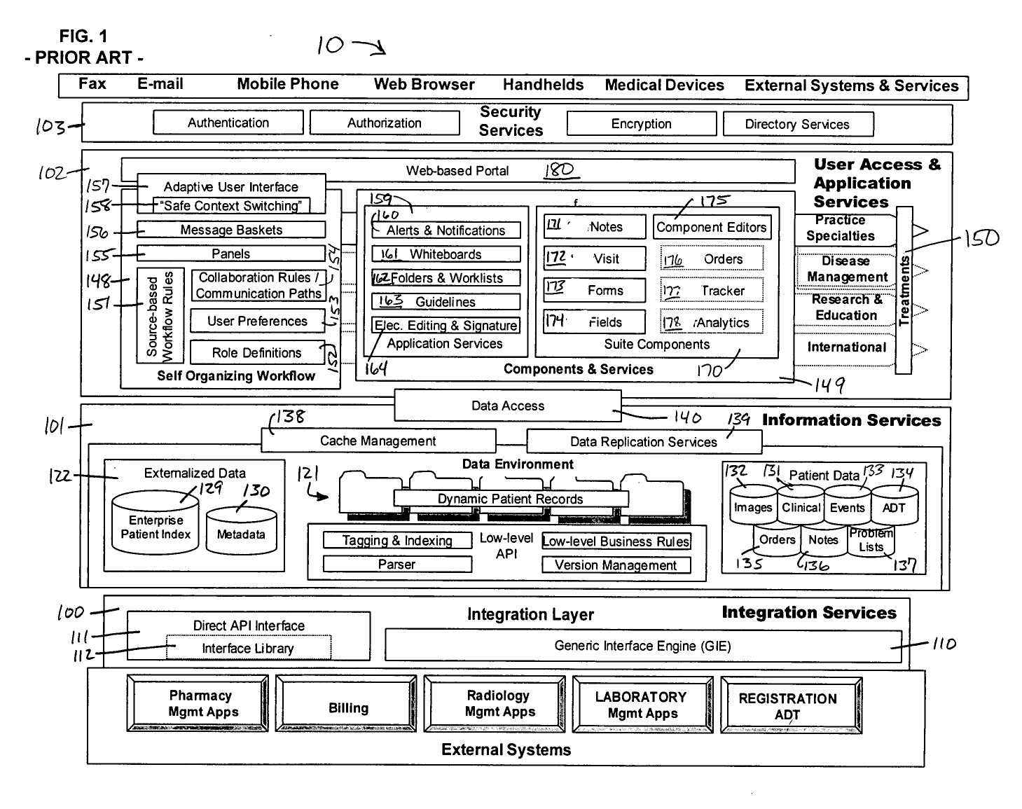

FIG. 1 is a block diagram of a prior art system framework for organizing, aggregating and integrating structured and non-structured data from a number of heterogeneous systems that may be used in one or more embodiments of the present invention. In FIG. 1, a known enterprise information architecture framework 10 is used to separate the management of corporate information assets, such as data definitions, business rules and patient data, from the transaction processing systems that support operations within the facilities that make up the medical center and support its affiliated practices. This architectural approach has evolved to include data for over 1 million patients, over 39 million tagged documents, over 300 GB of scanned images and PDFs, and direct links to images in the picture archiving and communication system (PACS) repository. Enterprise information architecture framework 10 may include four architectural layers including an integration layer 100, an information layer 101, a user access and application layer 102, and a security layer 103.

In FIG. 1, integration layer 100 may provide integration capabilities to external systems and data sources. Integration layer 100 includes three major components. First, a direct application programming interface (API) 111 that integrates information into the data access layer (101). Second, a generic interface engine (GIE) 110 component that supports the complex management, guaranteed delivery and synchronization of data between the source entity and data access layer 101 Lastly, an interface library 112 so that established connections with a particular version of a source system may be reused.

In FIG. 1, information layer 101 may provide a comprehensive framework for aggregating, harmonizing and providing core access to a broad spectrum of structured & non-structured healthcare information that exists within and across a healthcare organization. This is a central component to the overall architecture framework 10 and provides a base upon which both the functional components of the framework and other external systems can leverage. Information layer 101 may include five major components including a low-level API 120, a dynamic patient records/charts component 121, externalized data components 122, one or more, patient data resource component 123, and data access components 124. Low-level API 120 is responsible for and may include a parser 125 for processing recognizing external data that is presented via integration layer 100; a tagging and indexing component 127 for identifying and classifying the data for incorporation into the patient record by tagging and indexing the data; a version manager 126 for rationalizing multiple versions of the same data item (such as a transcribed note) as it pertains to existing data for the patient; and one or more targeted business rules 128, that need to be executed, as necessary, based on policy and the type and content of the data.

In FIG. 1, dynamic patient records/charts 121 may represent a complete view of the patient information that it manages for each patient. This information may include an overview of the chart, for example, all documents available in the chart; individual data items/documents; patient history; an overview of all lab results; individual lab results; clinical notes; patient images & other patient related data.

In FIG. 1, externalized data components may consist of an enterprise patient index 129 and metadata 130. Both of these data sources may provide a high-level representation and linkage to the actual patient data managed by information layer 101.

In FIG. 1, patient data resources component 123 may include all elements that make-up a patient record. The data elements that can be included may span the full spectrum of healthcare information. For example, these elements may include clinical data 131, which may include all clinical data except images; an image & fax archive 132, which may include all images, including scanned, faxed, and uploaded images; a clinical events database 133 that may include time-based information regarding patient encounters & chart modifications (labs, pending labs, other reports); an ADT cache 134, which may include demographics and insurance information; an orders database 135, which may include a most recent snapshot of all orders for one case; a notes database 136, which may include clinician notes from transcription services, surgical systems or other clinical source systems; and a problem list database 137 that may house each patient's current problem list, and current medication list as separate sections. In addition, patient data component 123 may include web chart caches than may include virtual processed patient charts; a merge database that may store information about merged Medical Record Numbers; and worklists that may include collections of work items, such as documents to be signed, faxing status of faxed-out documents, requests generated via forms. In addition, information layer 101 may manage patient data resources that physically reside within the information layer 101 environment and resources that reside within external systems. This flexibility allows users to incorporate data into the information layer 101 in the framework using a model that best suits their particular situation.

In FIG. 1, data access components 124 may provide the functional components of information services layer 101 as well as external systems access to the patient information managed within the framework. The components may include cache management services 138 that may manage the records and charts in dynamic patient records/charts 121; data replication services 139 that may support the replication of information to redundant data access layers or other external systems as appropriate; and core data access services 140, which provide both internal business logic components and external applications access to dynamic patient records.

Further, in FIG. 1, user interface and messaging and communication layer 102 may provide a framework of functional and user interaction components that make up the actual application capabilities available through framework 10. User access and application services layer 102 may include three major groupings: user interface & self-organizing workflow components 148, functional components & service 149; and specialized treatments 150. The first grouping involves a user interface and self-organizing workflow capability that fills a central role in managing overall user interaction. This model combines the formalized rule processing of traditional workflow systems with a flexible, user-driven model that better supports the highly collaborative and multi-threaded requirements of patient care. This grouping may include: user & system driven worklists that execute formalized processing threads based on a number of factors ranging from data content to time variables to organizational policies; a flexible task and data organization model consisting of patient and team panels 155 & message baskets 156; and an adaptive user interface model 157 that aggressively promotes multi-tasking while preserving safety of unintended updates or data loss, for example, may provide for safe context switching 158. Workflow and communication is managed based on the specific role of a first user 152 (e.g., a physician, nurse, administrator, etc.) the user preferences (e.g., notification timeframes, contact information, etc.) set-up by a second user 153, both user defined and organization defined source based workflow rules 151 (e.g., lab results; high-priority patient requests, note sign-offs) and collaboration rules/communication paths based on the interaction of the components described above.

The second grouping may include components and services that provide the base of business logic applied across healthcare practice areas. An application services 159 may include functional services that can be used across multiple functional components, for example, these services may include alerts & notifications 160, electronic whiteboards 161; folders & worklists 162; clinical guidelines incorporation 163; and electronic editing & signature services 164.

In FIG. 1, components and services 149 may include suite components 170 that provide functionality to support the clinical process in both an in-patient and out-patient setting. Suite components 170 may include: notes 171 to support physician notes capture and processing; visit 172 to record and manage patient visits; forms 173 to support specific forms processing requirements; fields 174 to improve the automated capture of common clinical information; component editors 175 including, for example, a problem list editor, a vital signs editor, and an immunizations editor; orders 176 to improve clinical order capture and processing; tracker 177 to allow populations of patients to be identified (based, for instance, on diagnoses and lab results), and tracked for important clinical events; and analytics 178 to help analyze and report on clinical information across the patient population. In addition, suite components 170 may also include: fax (not shown due to space constraints) to handle faxing information from patient charts and doc (not shown due to space constraints) to support transcribed documents from external transcription vendors. Of course, both the breadth and depth of components and services supported within the overall framework may be expanded.

In FIG. 1, the final grouping in user access and application layer 102 may include specialized treatments 150 that provide customized capabilities across the first two groupings (information services layer 101 and integration services layer 100) to address specialized market opportunities. For example, these opportunities may be focused on specific practice areas such as Pediatrics & Ophthalmology. Over time these treatments will likely expand to cover disease management, research & education and international versions of the framework.

In FIG. 1, security services layer 103 may describe the user access model and security services that govern access to the framework. For example, the framework may be accessible through a web browser interface 180 to support any highly mobile process that may exist in clinical settings. Users may access the system from any workstation with connectivity to servers on which the framework may be implemented. This connectivity may be via an internal network or via the Internet depending on the needs of the user. In addition, user access capabilities may include hand-held devices, mobile phones and other user devices that now support internet-based technology. Security services protect against unauthorized access to the system and/or related data/information and may include user authentication capabilities via user name/password, radio frequency identification (RFID), or biometric identifiers, encryption capabilities for data sent over a network and a redundant firewall infrastructure configuration.

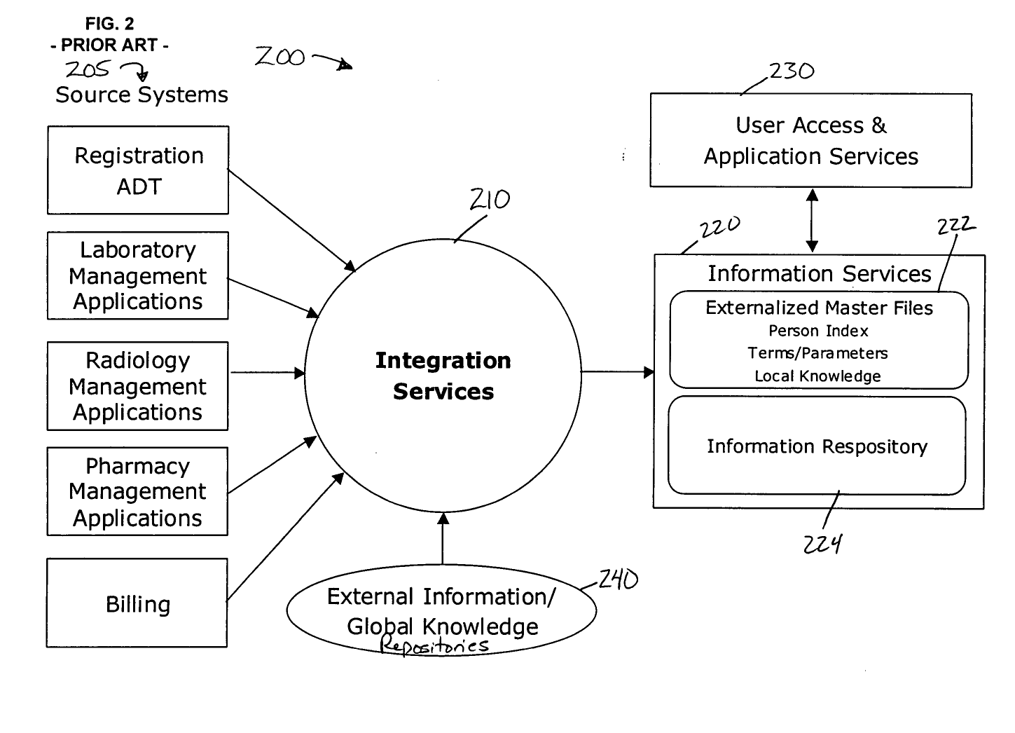

FIG. 2 is a block diagram of a known integration model for integrating data from heterogeneous systems into the system framework of FIG. 1 that may be used in one or more embodiments of the present invention. In general, regional is used herein to represent a geographic area in which some providers, data sources users, etc. are considered to be located remotely from the system framework and data and information that is aggregated therein. Therefore, a region may include a local region that may only include a few adjacent cities, towns and/or counties, as well as, multiple non-adjacent counties in a part of a state and/or states, all counties in a specific state, all states in a region of the country, and all states in the country. In FIG. 2, an information architecture 200 is illustrated that permits vendor applications and locally developed informatics tools 205 to operate as components supported by a shared set of information resources and repositories.

In FIG. 2, access to and update of repositories and logical unit of work may be managed via integration services subsystem 210. Role specific workflow tools may include top support functions such as patient lookup, ordering, reporting and escalation. Systems that support operations may be reduced to business engines for the areas they support. The components depicted with rounded edges may represent enterprise information resources managed external to any application system. Business logic may be externalized in an information services component 220 in “master files” 222 or linked in from the national level via the Internet. In addition, information services component 220 may include an information repository 224. Data of general interest may also be externalized in external information/global knowledge repositories 240.

In FIG. 2, enterprise information architecture 200 may be structured to decouple the management of content from the applications or tools that provide functionality for users. A key tenet of the architecture is to represent meaningful content outside of the various application systems, and to align the applications by importing and using this externally defined content in a standard manner throughout. Information, such as metadata and organizational knowledge that might otherwise be entered into application-specific master files, may be externalized in generalized tables. This information may be structured to make its meaning explicit and accessible; for example: external tables may store the identity of medical center personnel and a mapping to their roles; clinically meaningful diagnostic information may be stored externally, with mapping to the administrative equivalents in individual ancillary systems; and, the set of clinical concepts that can be measured in the laboratory may be stored externally, with mappings to the various billing codes associated with each concept in ancillary systems. Certain applications may use these externalized tables directly. It often may be necessary to manually copy the information into the profiles of legacy systems. In either case, each new application may reuse prior definitional work. Only newly required information may need to be added to the generalized tables, and the relation of such new information to existing information can be made explicit as it is added. In general, this approach saves implementation time while pre-aligning meaning across otherwise disparate applications.

Similarly, data that are captured or managed by an application, but which are used by more than one application, may be externalized into generalized repositories. A set of disparate repositories may exploit the strengths of their respective technologies. For example, highly structured, coded clinical data may be represented in relational tables, and in contrast, an indexed text repository, may be organized according to a document paradigm, provides a single logical source for all clinical reports about a patient, be they binary data, images, or text. Some reports may be stored in this repository as symbolic links (e.g., links from textual radiology reports to their corresponding images in the Picture Archiving and Communication Systems), while others may be copied directly from primary sources and stored directly in the repository, for example, EKGs.

For example, the indexed text repository may be a non-relational, hyper-indexed database implemented in Perl on a distributed processing system. The lowest tier, known as the integration layer 100, may implement distributed processing, queue-based transaction processing, process control and monitoring, and inter-process communication. Database layer 101, may implement permanent data storage, automatic replication across servers in different geographical locations, and conversion of clinical data from all sources into a common internal representation. Common views such as the assembly of documents and data related to a patient into a browsable electronic chart may be cached to reduce search demands. The application layer may implement transaction and business logic, such as the handling of corrections and updates in stored documents, and the handling of different evolving stages of individual data items (from pending to preliminary to final to corrected report, for example). This layer may be shared by all applications that use the repository, and hence provides the single place where transaction and business logic is maintained and applied. It may provide request broker functionality to support application interface services, report distribution services, and a number of web-based interfaces.

The externalized repositories may leverage database techniques to solve a class of problems that are difficult to handle through data processing strategies characteristic of transaction processing systems. One of the repositories may include an Enterprise Patient Index, a table of identifying numbers (e.g. medical record number, social security number, etc.), a table of names (e.g. current, maiden, married, etc.) and linkages of those numbers and names to instantiate people. As mistakes are made and corrected, linkages may be updated. A query may be all that is needed to assemble all record “fragments” for a patient. This approach avoids the complicated processes related to reconciling and merging records characteristic of classic enterprise master patient index systems.

In accordance with one or more embodiments of the present invention, the architecture and the electronic patient chart may interact with a variety of commercial systems and locally developed informatics tools in use throughout the facilities in the integrated delivery system. For example, the externalized application-independent repositories may serve two types of middleware function. First, when an application combines two concepts into one variable, the meaning can be decomposed into a set of granular data on the way into the repository, or assembled from multiple data on the way back into the application. In this fashion, required translation may be limited to a “plug-in” between the application and the repository without burdening other applications. As applications converge around common metadata, the plug-ins may be removed. Difference in the use of the concept of case, encounter, and visit among applications may be a simple example where it is helpful to disambiguate through the repository. Second, when two different processes provide different views of a related datum, those views can be represented “side by side” instead of picking one or the other. For example, the admitting office may be responsible for updating the attending physician field that is used for billing purposes, while the clinical care team on the patient's ward may represent the most reliable source of this information. However the ward team does not possess the admitting office's understanding of the correct timing of recording changes to comply with billing requirements. The solution may be to record both views of the data (administrative and clinical versions of “attending physician”, and to have a process for reconciling differences just before midnight, or just before the deadline for billing corrections).

In accordance with one or more embodiments of the present invention, application components may connect to the collective externalized tables and repositories through a single logical point, serviced by communication management engines, a Generic Interface Engine (GIE), which may use, for example, IBM's CICS™ as a transaction-processing environment. In the future, the GIE may be ported to other transaction-processing and/or application integration engines, such as, BEA WebLogic, and/or other similar products from, for example, Quovadx and/or Vitria. The GIE provides transaction logging, protocol conversion, one to many routing, and request broker functionality. It uses queuing mechanisms to loosely couple inter-application communication. At the same time, it manages acknowledgements so as to insure serialization and logical unit of work across components. Since the proactive end-to-end management of interface transactions provided by the GIE requires application-specific development, a commercial interface engine provides an alternative path for less demanding situations. In addition, efficient query services exist to provide applications with access to some commonly used repositories for transactions that do not result in updates.

Web based interfaces to information layer 101 of FIG. 1 may provide access to the electronic patient chart and support for related workflow. A one-patient-at-a-time interface provides access to the integrated clinical picture for one patient. A panel management or practice-oriented interface allows entire sets of patients to be accessed and reviewed in a single logical operation, and includes a result notification component. A number of additional interfaces are used for data entry, validation, document submission, document signature, report generation, and ad-hoc querying.

In FIG. 2, vendor “best of class” transaction processing source systems 205 may continue to operate as components within the information architecture in some embodiments. However, such “legacy” systems may be acquired and used in the context of the overall architectural philosophy, not just to address a specific task. For example, a vendor system that is otherwise “best of class” need not be purchased if it is unable to interface with other important aspects of the overall architecture.

In FIG. 2, the use of these transaction processing systems may be restricted to workflow within an operational area such as the laboratory. Data of interest to clinicians, educators, or administrators outside of an operational area may be externalized to the repositories where the data can be accessed by appropriate tools that integrate into other workflows. Although it may be increasingly possible for such applications and tools to share directly a single data repository, it may be useful to treat the “application” database and the external database repository as distinct architectural layers to isolate corruption and to separate management of data that may be work in progress from data that is in publishable form.

For example, laboratory test orders generated by WizOrder may be printed on the patient's ward (as a part of the “requisition generation” process) with a bar coded patient and test identifier, used for sample collection on the ward. At the same time WizOrder generates the order, an electronic copy may be sent via the GIE into an enterprise repository. Specimens arriving in the laboratory system may be processed via LabTalk2, which is a middleware application that reads the bar code on the requisition, obtains the corresponding detailed order information via the GIE from the enterprise repository, passes required test-related and patient-related information into the laboratory system (via the GIE), and returns (via the GIE) an “in lab” status to update the repository. As results are generated in the laboratory system, they are handed to the GIE for transmission to information layer 101 for result reporting and escalation. Because all tests that are ordered do not result in specimens delivered to the laboratory, the foregoing system may eliminate the need for a complex interface queue management between the order capture system and the laboratory system. It may also provide a status tracking mechanism for all stages of laboratory test processing, from ordering, to performance, to resulting. Since integration may be provided by the enterprise-wide ordering and repository layers, the laboratory has the freedom of using multiple simple systems that rely on the enterprise architecture, rather than requiring a large, complex, vertically integrated, and expensive laboratory information system.

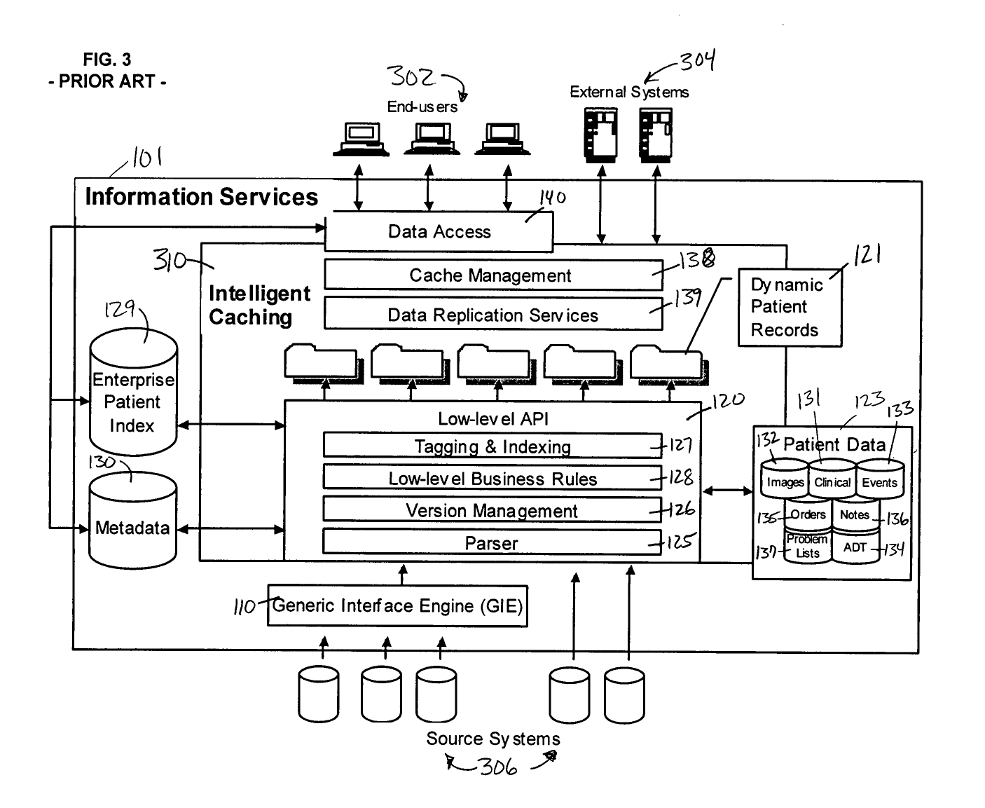

FIG. 3 is a detailed block diagram of a known information services layer in the system framework of FIG. 1 that may be used in one or more embodiments of the present invention. In FIG. 3, information layer 101 from FIG. 1, is shown with arrows indicating the direction of possible data flows and interaction with external end-users 302; external systems 304; and external source systems 306.

The model in FIG. 3 better addresses the needs of the clinical-focused healthcare market by providing the following benefits: providing dynamic, real-time collection of distributed system data; allowing distributed data to be proactively processed ensuring better data quality, for example, parsing, version management, and low-level business rules; tagging and indexing source data rather than mapping the data field for field, this allows all data to be incorporated in the consolidated model; modeling and data-mining metadata over time to derive deeper relationships from within the data; as data changes, the consolidated data store can be rebuilt without loss of data; and significantly speeding up access times for end-users.

In FIG. 3, information layer 101 may operate to collect input from GIE 110 that may be sent to low-level API 120 of an Intelligent Caching Engine 310. Parser 125 in low-level API 120 may parse the data to derive key identifiers, and, based on the key identifiers, low-level API 120 may apply versioning rules against the most recent dynamic data representation to establish the most current patient record. Tagging and indexing component 127 may tag and index the data based on the key identifiers and low-level API 120 may also update Enterprise Patient Index 129 to reflect the most recent changes to the data. A new dynamic data record may be established and placed into cache. When an user or external system requests patient information, information layer 101 may retrieve the dynamic patient record from an intelligent cache via intelligent cashing engine 310.

Data resources available internal to information layer 101 may include:
Patient Chart clinical data: includes all clinical data except images (these data elements could be housed internally or linked to externally)
Image archive: all images, including scanned, faxed, and uploaded.(these data elements could be housed internally or linked to externally)
Web chart caches: includes processed patient charts, stored on Web servers for performance.
Merge database: stores information about merged Medical Record Numbers (MRNs) (for patients with multiple MRNs).
Problem list database: Houses each patient's problem list, as separate sections. Reflects the most recent problem list document in the data access layer.
Orders database: most recent snapshot of all orders for one case.
ADT cache: demographics and insurance information.
User state and preferences: user state, preferences, etc.
Session context: transient context information
Recent patients: information about when a patient's chart was last pulled up by a user
“When seen” database: timestamp of the last acknowledgment of new results, by user and by patient
Teams: sets of user IDs organized into teams
Panels: sets of Medical Record Numbers and references to other organized into teams
Deleted Messages: information about all deleted basket messages, including reason given for deletion if the message was not saved to data access layer
Basket groups and Domains: logical groups of baskets, by clinical domain.
Access log files: audit log of all operations performed via information services layer 101 and user access and application services layer 102.
Worklists: collections of work items, such as documents to be signed, faxing status of faxed-out documents, requests generated via forms.
Accounts: authentication information; some authorization information (major group membership).
SecurID accounts: information about the SecurID logins
Recently modified stamps: timestamps of when each chart was last modified (labs, pending labs, other reports).
Fax database: name, address, phone/fax numbers, organization of fax recipients.
Demographics/ADT cache: cache of patient demographics, insurance information, etc.
Reminders users' self reminders about individual patients
Groups: mapping of internal Lab test codes to clinically meaningful test names\

The types of internal data captured may expand based on the specific source data being incorporated into the data access layer.

Data resources available external to information services layer 101 may include:
Enterprise Patient Index. An indexed database that holds a unique identifier for each patient along with key demographic information and other cross-referenced identifiers.
MetaData. A data description database used to standardize key nomenclature elements across heterogeneous sources.

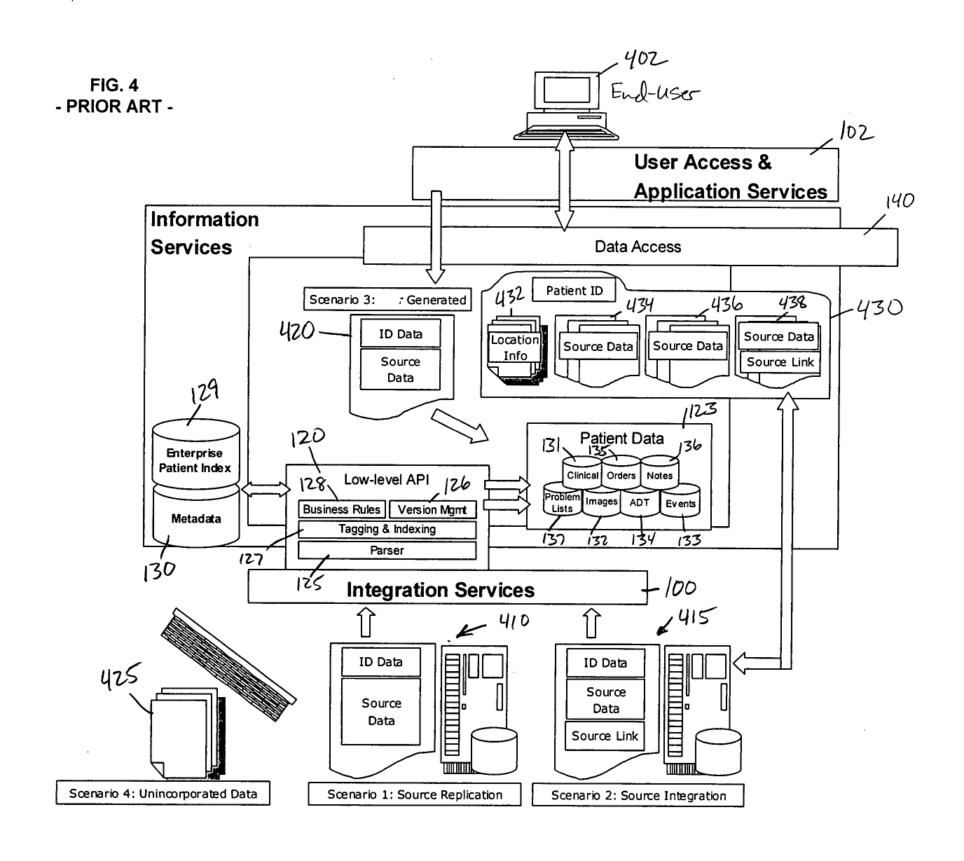

FIG. 4 is a block diagram showing multiple known scenarios for virtual data integration of data distributed across known heterogeneous source systems into the information services layer of FIG. 3 that may be used in one or more embodiments of the present invention. In FIG. 4, four data integration scenarios are illustrated, for example, a source replication scenario 410, a source integration scenario 415, a system generated scenario 420, and an unincorporated data scenario 425. Source replication scenario 410 involves incorporating all source data from the source application into information layer 101 and may be represented in a second source data element 436. Source integration scenario 415 involves incorporating summary information and a link to additional source detail (e.g., images, ECG readouts, etc.) in third source data element 438. For example, the source data in 438 may include a description of the image and the link may point to the location of the actual image. User access and application layer 102 incorporates this data as requested via link information. System generated data scenario 420 involves data generated from an end-user 402, for example, a clinician, through user access and application layer 102, where the generated data may be stored in a first source data element 434. Unincorporated data scenario 425 accounts for data that remains manual and user access and application layer 102 has the capability to represent manual location information for unincorporated data that is maintained manually and may be stored in location information 432.

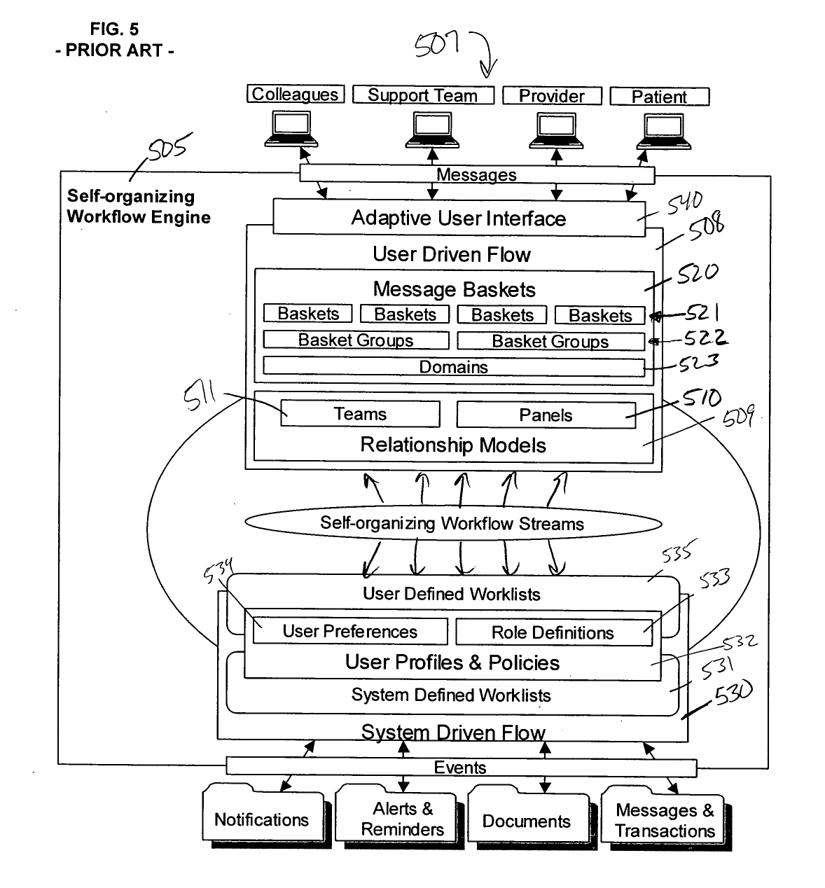

FIG. 5 is a detailed block diagram of a known self-organizing workflow model in the system framework of FIG. 1 that may be used in one or more embodiments of the present invention. In FIG. 5, user access and application layer 102 may provide a framework of functional and user interaction components that make up the actual application capabilities available through the overall framework. User access and application layer 102 may include three major groupings. The first grouping may involve the user interaction and self-organizing workflow capabilities that provide the framework for how users may interact with the system.

The self-organizing workflow model, in FIG. 5, may fill a central role in managing overall user interaction within the framework. This model may combine the formalized rule processing of traditional workflow systems with a flexible, user-driven model that better supports the highly collaborative and multi-threaded requirements of patient care. This formalized rule processing model may be implemented in a system driven flow 530, which may include system defined worklists 531, which may embody organizational policy; user profiles and policies 532; end user role definitions 533; user preferences 534; and user defined worklists 535. A user driven flow 508 may deal with how users may interact with data and information that may be received. User driven flow 508 may include relationship models 509, which may include panels 510 of patient records and teams 511 of care providers. User driven flow 508 may also include message baskets 520 with individual baskets 521, basket groups 522 and domains 523. An adaptive user interface 540 may enable end users 507 to access self organizing workflow 505 through role-specific views that are defined by each end user's role, for example, a doctor, nurse, etc. Some benefits of such a structure may include: (1) allowing organizations to focus the traditional workflow capabilities only on the key clinical and corporate rules that need to be applied consistently rather than trying to drive the entire process, which may minimize the amount of development and maintenance often associated with traditional workflow approaches; (2) in addition to traditional workflow, users are able to define and modify collaboration rules & communication paths to fit individual care plans, which may then be maintained by end users similar to normal system preferences thus reducing development and maintenance requirements; as input enters the system, these two models may be dynamically combined, as necessary, to produce a self-organizing workflow model to process the input, which, as processing occurs, may enable users to modify and extend collaboration rules, as needed; and this capability may be brought together by a highly adaptable user interface model to assist users to manage and interact with the multiple process flows inherent in the clinical environment.

The self-organizing workflow in FIG. 5 works by instantiating source data in user access and application layer 102 from information layer 101 and based on the source data, a self-organizing workflow engine 505 may establish which structured workflow rules apply. Also, based on the source data, self-organizing workflow engine 505 may establish which collaboration rules apply, and based on the applicable structured workflow rules and collaboration rules, a self-organized workflow model may be established and executed. Workflow interactions may be brought together into an adaptable user interface model that allows users to manage, interact and respond to multiple process flows. In addition, based on interactions and responses, collaboration rules and communication paths may adapt as necessary, and as additional input is garnered through the process, the source data may be updated creating additional iterations.

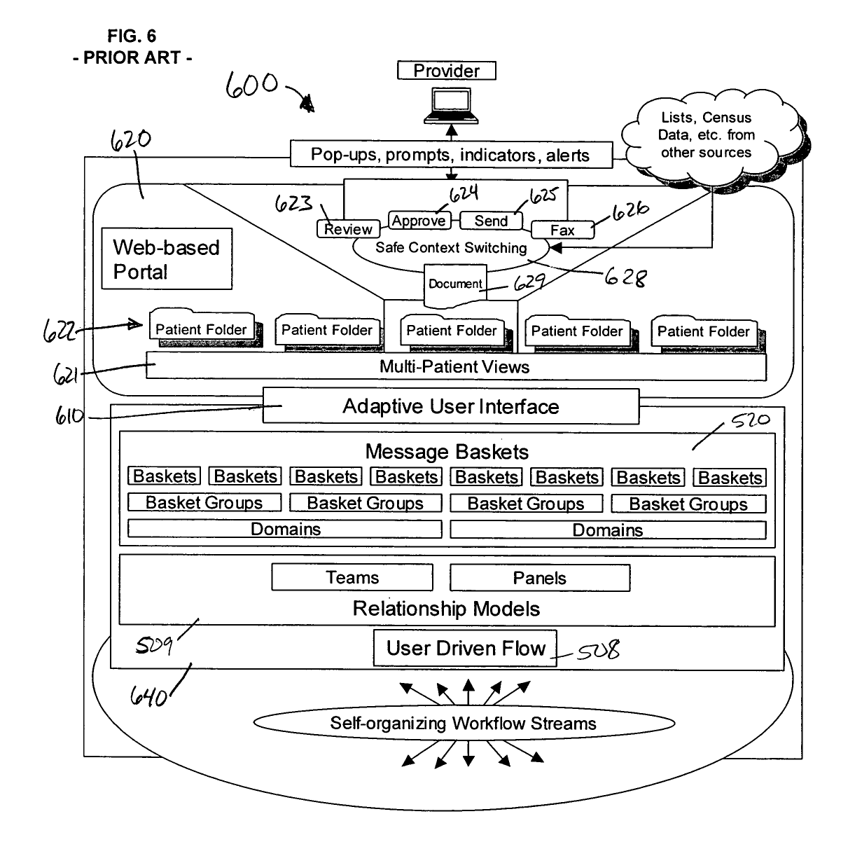

FIG. 6 is a detailed block diagram of a known user interface in user access and application layer 102 that may be used by a user and/or a provider to access the self-organizing workflow of FIG. 5 that may be used in one or more embodiments of the present invention. In FIG. 6, a user interface (UI) 610, for example, an adaptive user interface, may provide some or all possible options for a next step in a workflow 600. Benefits of adaptive user interface 610 may include aggressively promoting multi-tasking while preserving safety; supporting both single vs. multi-patient modes; the user interface may be integrated into a web-based portal 620 which allows the incorporation of external data needed in decision processes; automatic check-pointing of unfinished work; explicit notification; ease of continue/discard unfinished work to reconstruct a session using checkpoints, un-saved work, and session re-construct; and whiteboards as a part of multi-patient

In FIG. 6, adaptive user interface 610 may enable communication between web-based portal 620 and a user driven flow 640 and web-based portal 620 may provide access to store and/or access the data and information in user driven flow. Web-based portal 620 may include multi-patient views 621 and individual patient views 622. For any piece of information 629 that a user is accessing, the system permits via safe context switching 628 all possible next steps for working with the data. For example, as depicted in the diagram, possible next steps may permit users to review 623, approve 624, send 625, and fax 626 via safe context switching environment 628.

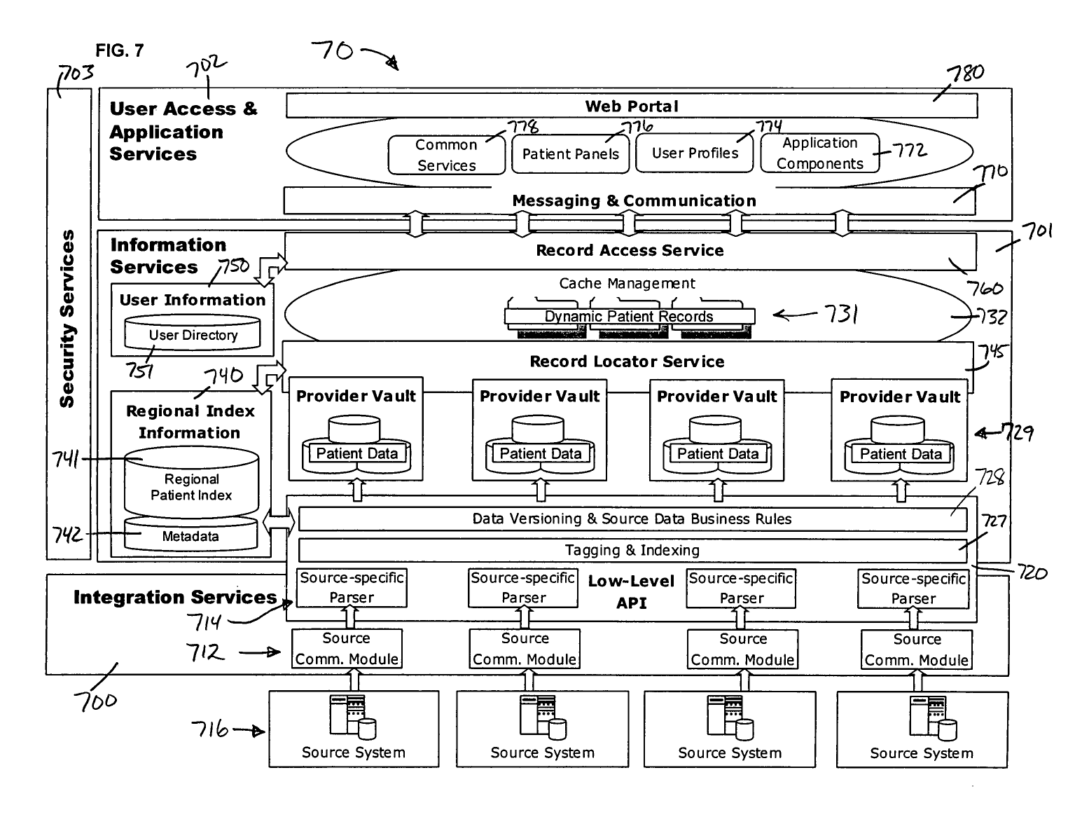

FIG. 7 is a block diagram of a system framework for organizing, aggregating and integrating structured and non-structured data from a number of remotely located, heterogeneous systems, in accordance with one or more embodiments of the present invention. In FIG. 7, an enterprise information architecture framework 70 is used to separate the management of corporate information assets, such as data definitions, business rules and patient data, from the transaction processing systems to support operations for a central data repository for multiple, diverse and remotely located medical centers and their affiliated practices and/or service providers. As previously described, the medical centers may be distributed over a large geographical area/region that may include up to and above thousands of square miles. Enterprise information architecture framework 70 may include four architectural layers including an integration layer 700, an information layer 701, a user access and application layer 702, and a security layer 703.

In FIG. 7, integration layer 700 may provide integration capabilities to external systems and data sources. Integration layer 700 may include multiple source-specific communication modules 712, multiple source-specific parser modules 714, and a low-level application programming interface (API) 720, which may be implemented to overlap from integration layer 700 into information layer 701 to integrate information into information layer 701. In addition, each of multiple source-specific communication modules 712 may be in communication with one of multiple specific source systems 716 that are providing patient data and information. In general, each source-specific communication module 712 will be in communication with a single source system 716, since the data received from each specific source system 716 may be different than all of the other specific source systems 706. However, it is also contemplated that, as data and information standardization is given time to occur, more than one of multiple specific source systems 716 may be able to share a single one source-specific communication module 712 as well as a single one of multiple source-specific parser modules 714.

In FIG. 7, information layer 701 may provide a comprehensive framework for aggregating, harmonizing and providing core access to a broad spectrum of structured & non-structured healthcare information that exists within and across multiple, unrelated and geographically remote healthcare organizations. These “regional” organizations may be distributed in a variety of scenarios. For example, the organizations may be distributed over a “region”, which may include multiple localities in and around a major metropolitan area (e.g., the city of Nashville and its surrounding counties), multiple counties in part of a state (e.g., all counties in the eastern part of Tennessee), all counties within a state, several states within a region in a country (e.g., the southern states in the United States), all states within the country (e.g., all 50 states in the United States and/or the 48 continental United States). This is a central component to the overall architecture framework 70 and provides a base upon which both the functional components of the framework and other external systems can leverage. Information layer 701 may include several major components including low-level API 720; a dynamic patient records/charts component 731; multiple source-specific storage locations 729 to store patient data originating from that source; a dynamic, high speed storage for patient records 731; a record locator service 745; a record access service 760 to facilitate data access, a user directory; and a regional index 740, which contains an index of all of the patient data stored in information layer 701. In general, in information layer 701, low-level API 720 is responsible for and may include a tagging and indexing component 727 for identifying and classifying the data for incorporation into the patient record by tagging and indexing the data; a data versioning & source data business rules component 728 for rationalizing multiple versions of the same data item (such as a transcribed note) as it pertains to existing data for the patient and one or more targeted business rules that need to be executed, as necessary, based on policy and the type and content of the data. Data versioning & source data business rules component 728 may be in separate communication with multiple secure storage locations, e.g., secure provider vaults 729, in which the data and information provided by each of multiple source systems 716 may be securely stored. To ensure data security in secure provider vaults 729, access controls are implemented to restrict who may access the data and information stored therein.

In FIG. 7, each of multiple secure storage locations 729 may be in communication with multiple dynamic patient records/charts 731, which may be implemented in a high speed memory structure including, for example, but not limited to, a cache memory. Information layer 701 may also include a cache management service 732 that may manage the records and charts in dynamic patient records/charts 731. Each of the dynamic patient records/charts 731 may represent a complete view of one patient's information that each of multiple secure storage locations 729 may manage for each patient across one or more provider vaults 729. This information may include an overview of a patient's chart, for example, all documents available in the patient's chart; individual data items/documents; patient history; an overview of all lab results; individual lab results; clinical notes; and patient images & other care related data.

In FIG. 7, in information layer 701, may include regional index of information 740, for example, a regional database index (i.e., a central/common index of the patient data and information) stored in multiple dynamic patient records/charts 731 and secure provider vaults 729. Regional index of information 740 may include a regional patient index database 741 and a metadata database 742. Both of these data sources may provide a high-level representation and/or link(s) to the actual patient data stored in provider vaults 729 and dynamic patient records/charts 731 that are managed by information layer 701. Regional index of information 740 may be in communication with provider vaults 729 via record locator service 745 for the purpose of creating a dynamic patient record 731 that aggregates information for a given patient from all of provider vaults 729 that contain information for the given patient. In addition, regional index of information 740 may be in communication with low-level API 720 via data versioning & source data business rules component 728. Provider vaults 729 may further be in communication with multiple dynamic patient records/charts 731 via record locator service 745.

In FIG. 7, each of multiple dynamic patient records/charts 731 may include all of the elements contained in provider vaults 729 that relate to a specific patient. The data elements that may be included can span the full spectrum of healthcare information. For example, these elements may include clinical data, which may include all clinical data except images; an image & fax archive, which may include all images, including scanned, faxed, and uploaded images; a clinical events database that may include time-based information regarding patient encounters & chart modifications (labs, pending labs, other reports); an ADT cache, which may include demographics and insurance information; an orders database, which may include a most recent snapshot of all orders for one case; a notes database, which may include clinician notes from transcription services, surgical systems or other clinical source systems; and a problem list database that may house each patient's current problem list, as separate sections.

In FIG. 7, information layer 701 may further include a user information component 750 which may include a user directory database 751 and be in communication with dynamic patient records 731 via record access service 760. User directory database 751 may be used for user authentication to determine the user's role and authorization to access patient information. In addition, user directory database 751 may be used to associate patients with given providers.

In FIG. 7, user access and application services layer 702 may include a messaging and communication component 770, which may provide communication pathways to information layer 701 via record access service 760. User access and application services layer 702 may also include application components 772, which are a set of tools that assist providers in working with patient information; user profiles 774, which may provide information on each user that may be used to determine the user's role, patient panels 776, are grouping of patients to assist providers in managing the patients for whom they are responsible; and common services 778, are basic sets of capabilities that help automate and improve critical processes, for example, patient messages, notifications, alerts, etc. User access and application services layer 702 may further include a web portal 780, which may provide access to application components 772, user profiles 774, patient panels 776 and common services 778 for external users.

In FIG. 7, security services layer 703 may provide the user access model and security services that govern access to the framework. For example, framework 70 may be accessible through a web browser interface to support any highly mobile process that may exist in clinical settings. Users may access the system from any workstation with connectivity to servers on which the framework may be implemented. This connectivity may be via an internal network or via the Internet depending on the needs of the user. In addition, user access capabilities may include hand-held devices, mobile phones and other user devices that now support internet-based technology.

In accordance with an embodiment of the present invention, a regional framework with an electronic patient chart may cover inpatient and outpatient activity for an ever-growing integrated delivery system distributed across geographic regions of varying size and dimension, for example, part or all of a state. The variety of sites may include the tertiary university hospital, the free standing tertiary children's hospital, a psychiatric hospital (plus outreach into the Nashville Public School system through the behavioral area), a rehabilitation hospital, a retirement and long term care facility, a home health program, hospital based clinics, and a variety of affiliated outpatient practices and disease management programs. All sites may use the electronic patient chart as a source to information. The majority of sites may contribute information to it. In addition, a secure process (through individual and group panels) for selectively allowing various practice groups (pediatrics, especially, but also psychiatry) access to the electronic records of their patients.

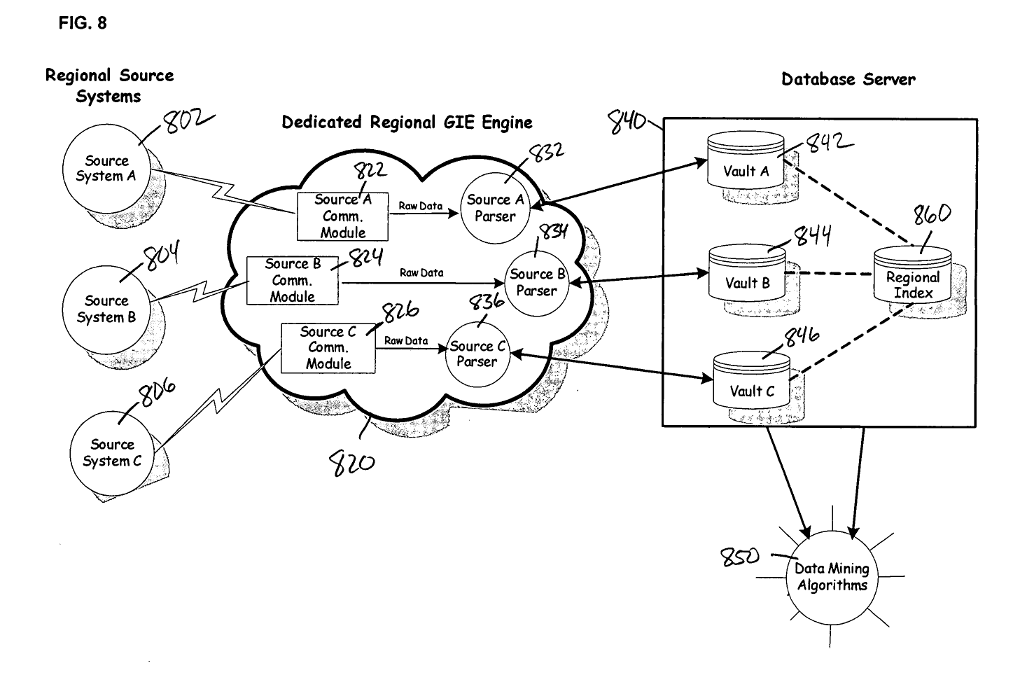

FIG. 8 is a top-level functional block diagram of an implementation of an integration architecture framework for integrating structured and non-structured data from a number of remotely located heterogeneous systems into the system framework of FIG. 7, in accordance with one or more embodiments of the present invention. In FIG. 8, multiple source systems, for example source system A 802, source system B 804, and source system C 806 may be geographically separated from each other and each may have a dedicated data feed to a dedicated regional GIE 820. GIE 820 may include a source A communication module 822, a source B communication module 824, and a source C communication module 826, each of which may queue raw patient data for one or more parsers, for example, source A parser 832, source B parser 834, and source C parser 836. Unlike, the single-parser system framework of FIG. 1, the system framework of the present invention includes separate, dedicated parsers for each source, for example, parsers A, B and C 832, 834, and 836, respectively. Not only do the separate parsers improve data throughput, but they also provide additional security for the data received from each source 802, 804, 806. After the raw data has been parsed by the appropriate parser(s), appropriate filters and/or business rules are applied against the data in a database server 840 and then stored in a participant specific database structure termed a vault. Based on security requirements, there may be one or more vaults per source. For example, vault A 842, vault B 844, and vault C 846 would correspond with source A, B and C respectively. Data mining algorithms 850 may later be executed across the participating vaults A, B and C 842, 844, and 846, respectively, to create patient specific entries for a regional index 860.

The simplest user interface that may be used and that meets the application requirements, starting with static HTML pages created offline; progressing to server generated pages; then to pages that include Java applets; then to pages with compiled ActiveX components; Java applications and finally to a locally installed C++ or VB client application.

In accordance with one or more embodiments of the present invention, a framework for development of rules may include the use of Java and Enterprise Java Beans (EJB) running under BEA WebLogic. In addition to the Perl framework which is the predominant model used in the prior art that is incorporated in this present invention.

Transactions that update the data repositories may be routed through one of the communication engines described above.

In accordance with one or more embodiments of the present invention, My SQL, Oracle, DB2 or other commercially available DBMS may be used as the enterprise structured data stores. Use of triggers and stored procedures at the database level is, generally, discouraged. Instead, data access logic may be stored at the information layer generally using either Java or Perl. Data access logic at this level minimizes the necessary access changes if the underlying database management system were to change.

In accordance with one or more embodiments of the present invention, in general, the ultimate vision is a regional patient-centric electronic health record, containing data from all points of care, and interoperable among the information systems of the variety of entities that make up the future health system of care. Such a health record will make it possible to achieve the goals of complete patient safety, high quality care, and cost effectiveness. Unfortunately, this vision clashes with the state of information management in most healthcare entities today, since their internal systems are usually not well integrated. In addition, because of the sensitive nature of patient data, patient data security requirements, for example, those defined in HIPPAA, must be maintained. Although progress has been made in the development and implementation of standards both from an interoperability and security perspective, they are neither complete enough, nor applied consistently enough, to support true interoperability across a region. Fortunately, embodiments of the present invention provide current interoperability solutions as well as pathways for future inclusion of all entities in an interoperable solution.

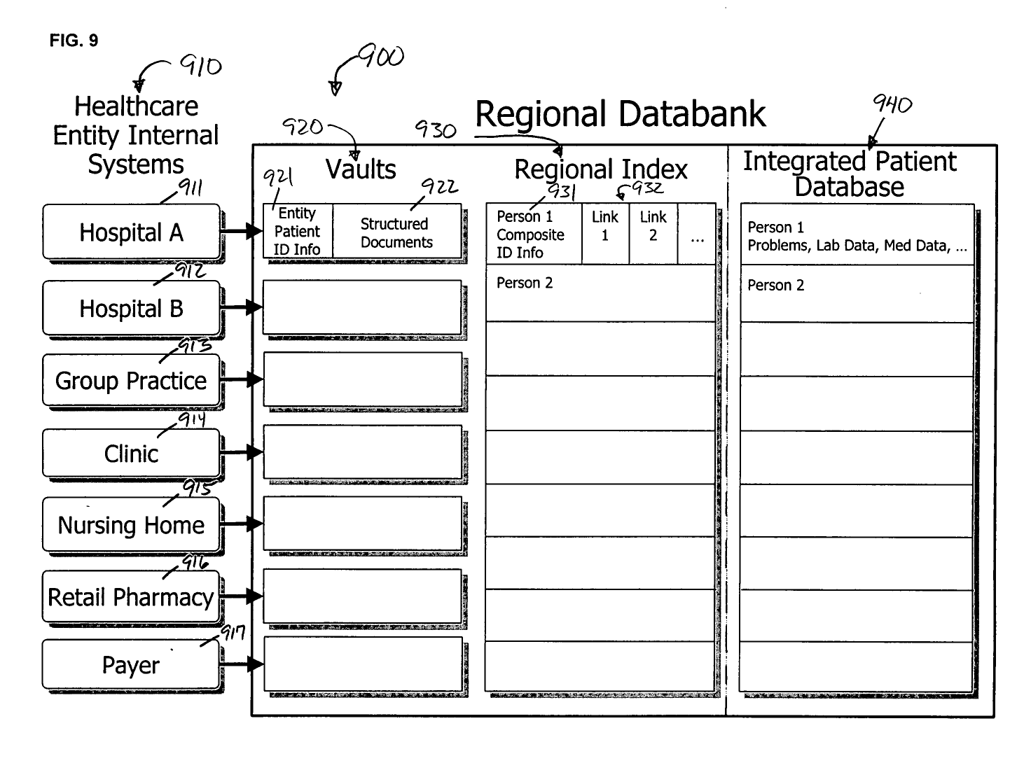

FIG. 9 is a block diagram illustrating possible structures of a regional databank for use in the system framework of FIG. 7, in accordance with one or more embodiments of the present invention. An embodiment of the present invention involves aggregating patient data in a common Regional Databank 900 from healthcare entities 910 including, for example, a hospital A 711, a hospital B 712, a group practice 713, a clinic 714, a nursing home 715, a retail pharmacy 716, and a payer 717. However, as depicted in FIG. 9, the data from each entity may be kept in one or more separate “vaults” 920 within common regional databank 900, depending on data security requirements. A regional patient index may be constructed to provide a unique patient identifier for each patient regardless of which vaults 920 contain clinical data for the patient. In addition, regional index 930 may provide pointers to which vaults 920 contain clinical information for a given patient that allows for a complete clinical chart to be assimilated and retrieved for the patient, as requested by an authorized user.

In FIG. 9, a first embodiment of regional databank 900 may be seen to include only vaults 920 and regional index 930, as shown by the dashed line running along the right side of regional index 930. Data may be received from multiple separate healthcare entities 910 and maintained in separate vaults 920 for each of the multiple separate healthcare entities 910. Each vault 920 may include entity patient identification information 921 for each patient associated with structured documents 922 for that patient. Regional patient index 930 may be constructed by analyzing all records across all of multiple separate healthcare entities 910 to identify records with matching identifying data. Regional patient index 930 may include separate records for each patient and each record may include composite identification information 931 and one or more links 932 to one or more structured documents 922 in vaults 920 and/or external data sources. Links 932 allow for a complete clinical chart to be assimilated and retrieved for a patient as requested by an authorized user via recorder locator service 745 from FIG. 7.

In accordance with one or more embodiments of the present invention, interoperability may be implemented in 3 stages. In stage 1, a patient's data from all healthcare entities may be made available for human viewing at the point and time of care via a web browser. In stage 2, displays that integrate related information from all healthcare entities become possible as those entities increasingly incorporate standards in their internal systems. It also may be possible to fire reminders on the basis of the regional databank 900. Stage 3 may achieve full interoperability as implementation of standards completes as well as more advanced analysis capabilities to allow participants to research the regional databank in a secure manner.

The advantage of this approach goes beyond the speed in which it can be accomplished. It will permit each healthcare entity to implement standards on their own schedule, which will buy the time needed for each entity to learn to work together and to build trust in the process.

Alternatively, in FIG. 9, in accordance with another embodiment of the present invention, in addition to the elements described for the first embodiment, in this embodiment, regional databank 900 may also include an integrated patient database 940. Integrated patient database 940 may include records for each patient in regional index 930, but instead of links 931 to structured documents 922, each record may include actual copies of all of the patient's data and information.

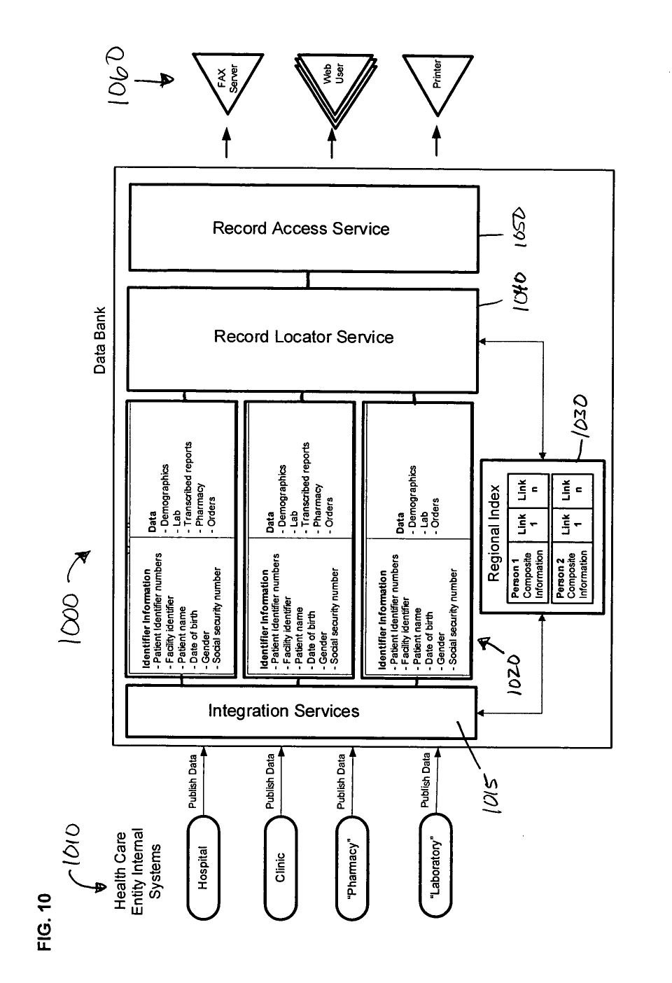

FIG. 10 is a functional data flow diagram associated with a regional databank in the system framework of FIGS. 7, 8 and 9, in accordance with one or more embodiments of the present invention. In FIG. 10, a regional databank 1000 may receive data and information from multiple health care entity internal systems 1010 via an integration services layer 1015. When the data and information is received for a patient, a check is made to determine whether the patient has previous records in regional databank 1000 and whether a patient identification exists for the patient. The data and information published by multiple health care entity internal systems 1010 and received by integration services layer 1015 may be parsed and mapped for inclusion in source entity specific vaults 1020 and a regional index 1030. A record locator service layer 1040 may utilize a regional index 1030 to aggregate all patient data from source entity specific vaults 1020, and a record access service layer 1050 may be used by users 1060 to access the aggregated patient data and information stored in regional databank 1000. Record access service layer 1050 may operate to create links between site records and regional index 1030.

A critical requirement for success in the sharing of data for a single patient, in FIG. 10, is the ability to correctly identify the correct person and the records containing data about that patient. The ideal solution would be the creation and use of a unique national identifier. Although discussions are taking place addressing this issue, it seems unlikely that such an identifier will be available in the near future. In the absence of that unique national identifier, an alternate choice is to identify a set of demographic parameters that collectively may be used to identify a person, and a number of algorithms exist that create an identification probability based on weighted matching of the selected parameters. Typical demographic parameters used to identify the patient might include full name (first, all middle, last) plus suffix; birth last name; gender; date of birth; place of birth; Social Security Number; mother's maiden name; street address of residence; and Zip Code. The matching algorithm uses these parameters with different weights to determine the match probability. If a match does not occur, a human must make the determination by acquiring additional data or making an informed judgment call. Multiple matches can be flagged and linked so additional factors can be identified and used to improve the matching statistics.

For example, the Indiana Primary Care Network uses a Person Identification deterministic method that provides high degree of accuracy on those patients it identifies and presents those patients (less than 10%) that it cannot identify. Connecting for Health, Phase II has created the Working Group on Accurately Linking Health to address this issue as well. This approach is similar to the Indiana approach. A number of groups are supporting the use of a voluntary national personal identifier. The advantage of such an approach is that numbers can be assigned locally but used when necessary at both a state and national level.

In accordance with one or more embodiments of the present invention, in FIG. 10, regional databank 1000 may contain a vault 1020 for each core healthcare entity 920 that contains the patient data for that entity. Each healthcare entity 1010 will have its own internal patient identifier. Each vault 1020 may include a database that contains the healthcare entity patient identifier (PID) plus the additional identifying data as supported by the entity's master patient index or equivalent structure. In addition, regional patient index (RPI) database 1030 may constructed to identify which of core healthcare entities 1010 contain clinical data for that patient.

Each vault 1020, in FIG. 10, may be identified by a healthcare entity 1010 identifier, and each patient's data for that entity may be identified by the entity's own patient identifier. As new patients are added or existing patients are updated, that entity's database is updated independently of any other entity's activity. Corrections to that entity's database are made by the entity and do not require updating other databases. In a sense, as far as each healthcare entity 1010 is concerned, this database is simply a replication of its own patient database.

In accordance with one or more embodiments of the present invention, RPI 1030 may contain the demographic parameters required for patient identification. Patients will be matched to each core healthcare entity's patient identifying data set as described in the above patient identification description. If the probability of a match exceeds the match threshold, a pointer to the appropriate healthcare entity vault 1020 may be added, along with the core healthcare entity's patient identifier and the probability rating for the match. The RPI may be contained in, for example, an Oracle database. However, other database systems may also be used.

The advantage of this approach is that all interactions between healthcare entity vaults 1020 and any other component of regional database 1000 may be eliminated. Each dataset is self-defining with contents expressed as a document using, for example, an HL7's clinical document architecture standard. Data corrected by any healthcare entity 1010 needs to be corrected only in its own vault in regional databank 1000.

As new patients are added to regional databank 1000 or existing patient records are updated, the RPI 1030 is recreated for that patient in real time. RPI 1030 also can and will be periodically rerun against each healthcare entity master patient index to rematch all patients in case of matching patient algorithm changes. This strategy again eliminates the necessity of chasing those changes through a series of databases. It is possible that the process of matching patient records will reveal multiple records for the same patient in a given vault. In this case, the healthcare entity would be notified and have the opportunity to merge the records.

One serendipitous advantage is that healthcare entities 1010 having multiple sites but separate record systems can integrate data from the sites within their own systems.

The HIPAA National Employer Identifier may be used as the healthcare entity identifier for each healthcare entity 1010. This identifier may be used to identify the vault containing data for a patient from that healthcare entity 1010. It may also be used to identify the source of clinical data in the shared data displays.

The final rule for the National Provider Identifier (NPI) was published on Jan. 23, 2000 and providers were able to apply for NPIs as of May 23, 2005. In the initial scenario, providers may be identified by each healthcare entity 1010 by name, and no common provider identifier database will be necessary. However, over time, it will be highly desirable to have a unique identifier for each healthcare provider that will permit tracking patients and providers. It will also be of value to have a single, regional provider database that insures up to date data on providers such as name, address, specialties, key numbers and other characteristics. Such an external database will eliminate the need for each healthcare entity 1010 to provide the resources necessary to create and maintain such a database independently.

While waiting for the assignment of the national provider index for all providers in a region, a provider registry may be constructed using a process similar to that for constructing the RPI.

The regional databank 1000 may support a variety of healthcare facilities including hospitals, clinics, group practices, solo practices, retail pharmacies, nursing homes, home health, emergency rooms, rehabilitation centers, skilled nursing, rehab facilities, dental facilities, and payers. These facilities will vary widely in their use of information technology from none to complete electronic health record systems. Most major commercial IT systems are in use somewhere in the demonstration region. It is also likely that each core healthcare entity will be using one or more terminologies that are local in origin. There will be little consistency in what data elements are collected, or at least what they are called and how they are collected. Initially, the use of health data standards will not be wide-spread. This is the environment from which data must be brought together for sharing as part of the health care process.

Fortunately, there is a spectrum of formats in which the data will be available over time and over the core healthcare entities. For some entities, the data will exist only in paper form and, in many cases, as hand-written notes. This data will be converted to electronic form by faxing it to the regional cnter to be stored as a scanned document. The next level of data format is unstructured text and much of this data represents transcribed dictation. The third level is tagged data with varying degrees of specificity—from data category such as immunization or lab data to specific data elements such as weight. The fourth level is standardized data that is tagged at the data element level and uses a standardized terminology. Finally, data could be structured as complex objects using HL7's clinical templates and common message element types (CMETs) standards. Fourth level data may be merged to create a structured, aggregated, patient-centric electronic health record that will permit pursuing all the desired outcomes of the framework.

Since most reference laboratories are using LOINC for test names and result names. If that data could be shared directly with the regional databank, the lab data could be integrated earlier in the cycle. The same opportunity may exist for medication data, capturing the data from the pharmacy benefits managers. In both cases, agreement of both patients and providers would be necessary. The advantage of building components of a merged patient-centric database early on would be to demonstrate value and provide a stronger motivation for moving more data categories into the merged databank.

Initially the data may be accepted in whatever format it currently exists in its home setting and replicated in the regional databank as described above. Having shared access to data at any format level has value and will improve decision-making. Clearly, as more data become available at the higher format levels, the value increases.

Initially, shared data accessed from the regional databank may simply be displayed separately for each Core Healthcare Entity. The interaction between the regional databank and the healthcare entity 1010 would be through an icon on the entity's home screen of the primary IT system. Clicking on that icon would provide access to shared data for the patient selected. If no data existed from other healthcare entities, a flag indicating this state would be returned to the user. For entities having no electronic capabilities, the shared data would be faxed to the provider. In this mode of operation, additions or corrections to a site's database using shared data would have to be made within a healthcare entity's own software through a manual entry. For example, if looking at shared data indicated an address change or name change, that change would have to be entered manually into the reviewing system.

Over time, as data become more standardized, more display options and queries of the regional databank 1000 will be available. Data may be displayed for a specific data category such as a medication list, allergies, immunizations, or a problem list. Data may be requested for a particular encounter or all values for a particular data element over time from all sites of care. Queries across multiple patients may be supported, if authorized.

For the actual data interchange, the health level data interchange standard may be used, for example, but not limited to, one of Version 2.5 standard or the Version 3 standard. In addition, the syntax used to separate the components of the message must be specified—whether HL7 encoding rules or XML. The most desirable choice would be Version 3 since it has a higher degree of interoperability and represents the future. Version 3 uses XML encoding and is based on the HL7 Reference Information Model standard. However, existing circumstances and current uses may dictate the use of Version 2. In general, all data will be encrypted for transmission.

The architecture of the regional 1000 databank must obviously accommodate the variety of format, form and type of data. Therefore, an electronic patient chart based on the HL7 Clinical Document Architecture standard may be provided to support this multiplicity of data types. The electronic patient chart may use the HL7/ANSI standard Clinical Document Architecture. This standard defines a header that contains the name of the document, the source or author of the document, the facility, the patient and the date and time. The CDA facilitates patient's clinical documents into a lifelong patient record, provides for a standardized exchange of patient data, and enhances the management of patient data. The body of the CDA permits the use of tagged fields to provide internal structure to the document. This tagged structure could be defined down to individual data elements. The CDA uses XML tags. This feature will be important for future stages of the project.

Each of the healthcare entities will be required to send the clinical data elements to regional databank 1000 using the HL7 data interchange standard, if electronic transmission of data is possible. The expense of the software required for this service will be born by each healthcare entity 1010. Each healthcare entity 1010 will build in access to the regional shared databank. Ideally, the HL7 Clinical Context Object Workgroup (CCOW) standard would be implemented to open the link to regional databank 1000 when the linkage icon is clicked, automatically passing the requested patient identification data set to the regional databank.

Initially, all available and authorized shared data may be displayed for the requesting healthcare entity 1010. The release of data will be controlled by the patient to specific providers, specific institutions, and specific circumstances. Emergency situations will override this control, but will be promptly reported to the patient. Authentication and authorization of the requestor will be required and will be accomplished by the healthcare entity. An access log of all data transfer will be made. This log will be available to the patient.

In addition, extended features may be included in regional databank 1000, for example, data may be integrated using the CDA headers to permit selective retrieval by category of data, by date, by provider, or by an encounter. Intelligent alerts and reminders may be generated from these loosely integrated databases, particularly as higher level of data format became available.

As a threshold level of healthcare entities 1010 begin to send data to the regional center at the fourth level of data format, a separate, integrated patient-centric database may be constructed. This database may enable the use of decision support algorithms, electronic disease management protocols, health surveillance, and other patient safety, cost containing, and quality assuring methods to be used in an automated system.

This course of action enables the final phase of the data sharing operation—the reverse feed of data. HL7 trigger events may be used to flag address changes or name changes. Subject to patient authorization, this data could be downloaded to all healthcare entities 1010 involved in that patient's care for automated update of their internal databases. A strategy of store and forward versus pull will need to be explored for the most efficient and effective way of keeping local databases up to date with critical data such as new allergies, new diagnoses, new prescriptions, new immunizations and such. An evaluation strategy needs to be in place to determine the value of this functionality performance and on the health of the population. Again, with the patient's authorization, the regional, patient-centric electronic health record may be downloaded to a new site at which the patient is seeking care. Both the patient and healthcare entity 1010 should rate this functionality with a high degree of satisfaction.

As part of the implementation, the initial creation of regional databank 1000 may require some download of clinical data from each participating site. Choices of this preloading of data include all data in electronic form, all data for a specified period of time, or a defined summary dataset. It is likely that, in the initial stages of startup, only certain, defined data elements or data types will be reported to regional database 1000. The system may permit dynamic expansion of this database. After the preload, the RPI 1030 may be created and evaluated on its ability to match patients. Having the healthcare entity master patient index available at the regional level will permit testing modifications to the matching algorithm.

Diagnoses and problem lists may be included in data sharing. Initially, problem lists would be shared as independent lists for each encounter. Tools may be provided to permit an institution to drag problems from these lists to create institutional problem lists, using a standard terminology and a standard structure.

Radiology and other similar diagnostic studies reports may be easily added as text documents or may be shared as standard image files, HL7 Clinical Document Architecture, Release 1.5 may be used for document reports, and either DICOM or JPEG standards may be used for images.

Comprehensive history and physical examination data may be shared through provider progress notes and discharge summaries.

Personal data may be expanded to include social and family history, financial data, and complete demographics. In addition, personal data may include a quality of life measure, a functional health status data element, donor agreements and advance directives may be added to the core data elements.

As healthcare interoperability standards are established the framework may incorporate those standards in its information and integration layers to make effective use of decision support algorithms, effective disease management, prevention of medical errors, determination of performance indicators, and linkage of data all require that semantic interoperability.

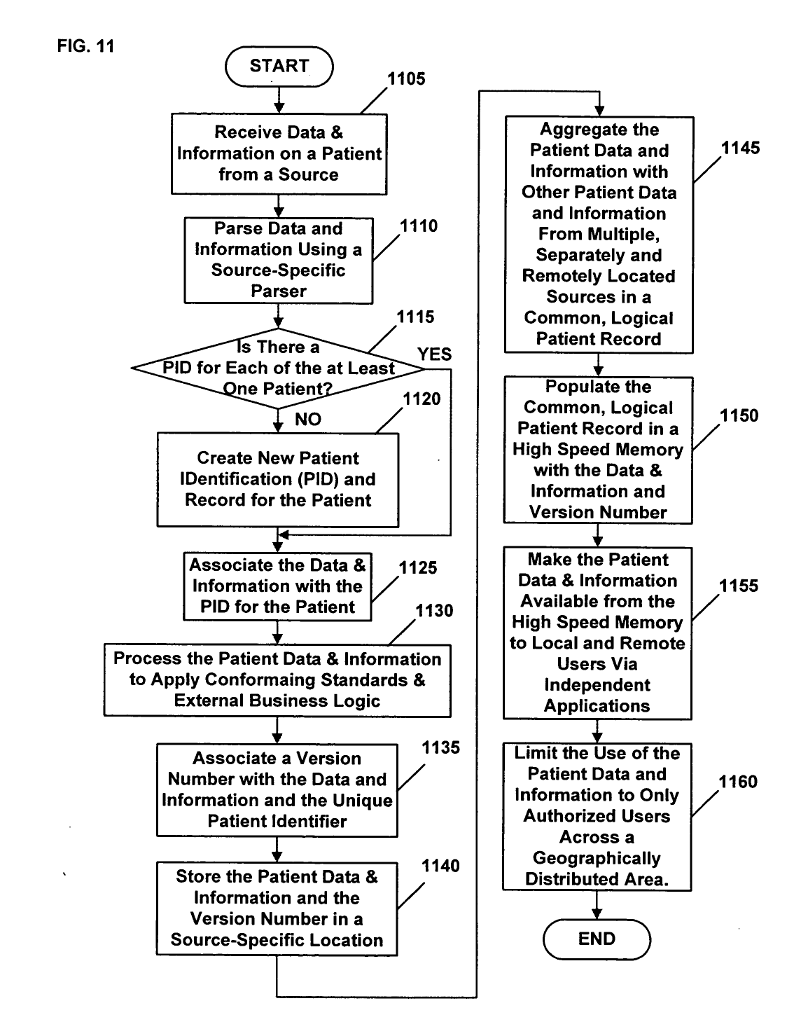

FIG. 11 is a top-level flow diagram illustrating the process of adding patient data into the regional databank and system framework of FIGS. 7, 8 and 9, in accordance with an embodiment of the present invention. In FIG. 11, the method may include receiving (1105) data and information on a patient from one of multiple remotely located sources, and parsing (1110) the data and information using a parser specific to the one remotely located source. The method may further include determining (1115) whether the patient has an existing unique patient identifier, and if the patient does not have an existing unique patient identifier, assigning (1120) a unique patient identifier to the patient. The method may also include associating (1125) the data and information with the unique patient identifier for the patient, processing (1130) the patient data and information to apply conforming standards and external business logic, as appropriate, and associating (1135) a version number with the data and information and the unique patient identifier. The method may also include storing (1140) the data and information and the version number in a location specific to the one remotely located source, aggregating (1145) the patient data and information with data and information accumulated from the plurality of separate remotely located sources into a common, logical patient record, and populating (1150) the common, logical patient record for the patient in a high speed memory with the data and information and version number. The method may still further include making (1155) the patient data and information available from the high speed memory for use by one or more applications and to one or more local users of a central repository and to one or more remotely located users of the central repository, each of the one or more applications being independently operable of each other; and limiting (1160) the use of the patient data and information to only authorized users across a geographically distributed area. Although not explicitly shown, a transaction log is updated to reflect all information changes and requests that occur in the regional database throughout performance of the above method.

The above description may be considered to illustrate the general principles of the invention and is in no way to be construed so as to limit the invention as expressed in the appending claims to the exact construction, implementations and versions shown and described.

What is claimed is:

1. An integrated method of identifying, aggregating and making accessible clinical information from remotely located heterogeneous sources, the method comprising:
receiving data and information on a patient from one of a plurality of remotely located sources;
parsing the data and information using a parser specific to the one remotely located source;
if the patient does not have an existing unique patient identifier, assigning a unique patient identifier to the patient;
associating the data and information with the unique patient identifier for the patient;
processing the patient data and information to apply conforming standards and external business logic, as appropriate;
associating a version number with the data and information and the unique patient identifier;
storing the data and information and the version number in a location specific to the one remotely located source;
aggregating the patient data and information with data and information accumulated from the plurality of separate remotely located sources into a common, logical patient record;
populating the common, logical patient record for the patient in a high speed memory with the data and information and version number;
making the patient data and information available from the high speed memory for use by one or more applications and to one or more local users of a central repository and to one or more remotely located users of the central repository, each of the one or more applications being independently operable of each other; and
limiting the use of the patient data and information to only authorized users across a geographically distributed area.

2. The method of claim 1 further comprising:
associating a source patient identifier from the remotely located source with the unique patient identifier in the central repository.

3. The method of claim 1 further comprising:
associating a plurality of source patient identifiers with the unique patient identifier in the central repository.

4. The method of claim 1 further comprising:
receiving data and information on a patient from a local source;
parsing the data and information using a parser specific to the local source;
if the patient does not have an existing unique patient identifier, assigning a unique patient identifier to the patient;
associating the data and information from the local source with the unique patient identifier for the patient;
updating the version associated with the patient data and information identified by the unique patient identifier;
storing the data and information on the patient in a location specific to the local source;
associating the patient data and information identified by the unique patient identifier from each of the plurality of separate locations in the central repository;
populating the dynamic patient record for the patient in a high speed memory with the local data and information;
making the patient data available from the high speed memory for use by one or more applications independently of each other to the local and remotely located users; and
limiting the use of the patient data to only authorized users across the geographically distributed area.

5. The method of claim 4 wherein the populating the dynamic patient record for the patient in the high speed memory comprises:
populating the dynamic patient record for the patient in a cache memory.

6. The method of claim 1 wherein the receiving the data and information on the patient from the remotely located source comprises:
receiving the data and information as at least one of
text;
an image;
an EKG;
an ECG;
an X-Ray;
a laboratory report;
a facsimile; and
clinical notes.

7. The method of claim 1 further comprising:
receiving a request for data on the patient from an authorized user;
determining the patient is in the central repository;
retrieving requested data from high-speed memory;
formatting the retrieved data based on the authorized user making the request;
displaying the formatted data in an interface for the source of the request;
determining the displayed data was changed;
updating the data and related links at the regional index using the patient identification;
updating the data in high speed memory; and
associating new patient data with workflow rules.

8. A machine-readable medium having stored thereon a plurality of executable instructions to perform a method, the method comprising:
receiving data and information on a patient from one of a plurality of remotely located sources;
parsing the data and information using a parser specific to the one remotely located source;
if the patient does not have an existing unique patient identifier, assigning a unique patient identifier to the patient;
associating the data and information with the unique patient identifier for the patient;
processing the patient data and information to apply conforming standards and external business logic, as appropriate;
associating a version number with the data and information and the unique patient identifier;
storing the data and information and the version number in a location specific to the one remotely located source;
aggregating the patient data and information with data and information accumulated from the plurality of separate remotely located sources into a common, logical patient record;
populating the common, logical patient record for the patient in a high speed memory with the data and information and version number;
making the patient data and information available from the high speed memory for use by one or more applications and to one or more local users of a central repository and to one or more remotely located users of the central repository, each of the one or more applications being independently operable of each other; and
limiting the use of the patient data and information to only authorized users across a geographically distributed area.

9. The machine-readable medium of claim 8, wherein the method further comprises:
associating a source patient identifier from the remotely located source with the unique patient identifier in the central repository.

10. The machine-readable medium of claim 8, wherein the method further comprises:
associating a plurality of source patient identifiers with the unique patient identifier in the central repository.

11. An information management framework to integrate and aggregate heterogeneous data and information from geographically remote sources comprising:
an integration layer to receive data from a plurality of remotely located sources, the integration layer including a plurality of source-specific parsers to parse the data received from each of the plurality of remotely located sources;
an information layer in communication with the integration layer, the information layer to store and provide centralized aggregation, integration and access services for the parsed data from the plurality of remotely located sources, the information layer including a plurality of secure storage locations to separately store the parsed data from the plurality of remotely located sources, an index of the received data to be used to access the data, a user directory to maintain a list of authorized users, and a high speed memory to store a plurality of dynamic records for the parsed data, the information layer being further to dynamically maintain and update the dynamic records with the parsed data and to provide the updated dynamic records to one or more local and remotely located authorized users;
a user access and application layer in communication with at least the data access layer, the user access and application layer to provide user interface and self-organizing workflow functionality, business logic to be applied across a plurality of different functional areas implemented in the regional information management framework, and customizable capabilities for providing the user access and application functionality and the self-organizing workflow and business logic; and
a security layer in communication with at least the user access and application layer, the security layer to provide security control and user interaction capabilities across the framework.

12. The information management framework of claim 11 wherein the information layer further comprises:
a record locator service in communication with the index of the received data to access the stored data from the plurality of secure storage locations and from the plurality of dynamic records in the high speed memory.

13. The information management framework of claim 12 wherein the information layer further comprises:
a record access service in communication with the user access and application layer to receive user requests from the user access and application layer.

14. The information management framework of claim 13 wherein the information layer further comprises:
a user directory in communication with the record access service to determine whether a user requesting access is an authorized user.

15. An integrated method of identifying, aggregating and making accessible information from multiple heterogeneous sources, the method comprising:
receiving data about an entity from a remotely located source;
parsing the data using a parser specific to the remotely located source;
if the entity does not have an existing unique entity identifier, assigning a unique entity identifier to the entity;
associating the data with the unique entity identifier for the entity;
associating a version number with the data and the unique entity identifier;
storing the data and the version number in a location specific to the remotely located source;
aggregating the entity data accumulated from multiple remote sources and stored in locations specific to the remote source in a common, logical view of the entity record;
populating the common, logical entity record in a high speed memory with the data;
making the entity data available from the high speed memory for use by one or more applications independently of each other and to one or more local users of a central repository and to one or more geographically remote users of the central repository; and
limiting the use of the entity data and information in the central repository to only authorized users across a geographically distributed area.
